(19) United States
(12) Patent Application Publication
(10) Pub. No.: US 2015/0043231 A1
(43) Pub. Date: Feb. 12, 2015

(54) Multi-Purpose Tailgate Sign device

(71) Applicant: John T. Clark, Noblesville, IN (US)

(72) Inventor: John T. Clark, Noblesville, IN (US)

(21) Appl. No.: 14/336,524

(22) Filed: Jul. 21, 2014

Related U.S. Application Data
(60) Provisional application No. 61/857,272, filed on Jul. 23, 2013.

(51) Int. Cl. F21V 23/00; F16B 2/02; F21S 8/10; G09F 21/04

(52) U.S. Cl. CPC F21V 23/003; G09F 21/048; F16B 2/02; F21S 48/00; G09F 2013/222
USPC 362/485

(57) ABSTRACT

An apparatus having a plurality of multi-colored light emitting diodes (LEDs) or another visual display system for signage and visual communication. A unique device which, as an illuminated sign, can be rapidly deployed in response to relatively quickly changing conditions and used for many uses such as traffic control from vehicles such as pick-up truck tailgates. It includes (a) a display system; (b) a way to power and control the display; (c) a manner to interconnect the power and control to the display; and (d) a way to removably mount the display to the tailgate or doors of a vehicle such as a pick-up truck whereby the Multi-Purpose Tailgate Sign device is used to safely and quickly deploy a display or signage with a vehicle such as a work truck.

### CROSS-REFERENCE TO RELATED APPLICATIONS

This application claims the benefit of Provisional Patent Application Ser. No. 61/857,272 filed Jul. 23, 2013 by John T. Clark and entitled “A Multi-Purpose Tailgate Sign device”.

### FIELD OF INVENTION

This invention relates generally to a multi-purpose tailgate sign device. Particularly this device is related to a road sign and information display apparatus which may be deployed as an improved safety warning device for vehicles. The apparatus becomes temporarily effective when the vehicle stands on the road in the way of other vehicles.

The display may be an apparatus having a plurality of multi-colored light emitting diodes (LEDs) or another visual display system for signage and visual communication. It is a unique device which, as an illuminated sign, can be rapidly deployed in response to relatively quickly changing conditions and used for many uses such as traffic control. The device relates to removable structures which can be used to support such signs and displays from vehicles such as pick-up truck tailgates.

### FEDERALLY SPONSORED RESEARCH

None.

### SEQUENCE LISTING OR PROGRAM

None.

### BACKGROUND

### Field of Invention and Prior Art

1. Problems Addressed

Setting up as well as changing road signs and information displays made from metal sheeting is laborious, which is a large drawback in the temporary use of signs, or changes of them, as well as setting up other information messages of temporary nature for road users. One object of the present invention is to achieve a road sign and/or information display apparatus which can be rapidly and easily placed in position and removed. This object is achieved with a device described herein as a road sign and information display apparatus in accordance with following description and accompanying drawings.

Further objectives are to overcome the situation that:

A. No signs are known which also incorporate an LED sign used to provide irregular or random light intensity to establish a desired lighting effect.
B. No signs are known which enable alteration of a light signal through remote manipulation or activation. Remote control of a sign is generally undesirable because radio frequency transmitters and receivers are generally costly and require a large power supply which is a concern for motor vehicles.
C. No signs are known which include features for optic communication and features for the generation of a visual image.

2. Prior Art

As far as known, there are no multi-purpose tailgate sign device or the like. It is believed that this product is unique in its design and technologies.

Prior Art 101 U.S. Pat. No. 3,761,890 issued to Fritts, et. Al. in 1973 and entitled “Variable Copy Command Module” demonstrated an apparatus comprising in combination a variable copy command apparatus including an enclosed container that may be moved between an upright position, that will permit oncoming motorists to view the copy message, and a lower position to decrease the air drag on the vehicle. The enclosed container included a movable transparent copy web, having a plurality of copy messages thereon, and reflective means behind the copy web to provide relatively brilliant daytime and night-time viewing of the copy message. It was strictly a car roof mounted sign an far more complex than the Clark device presented here. Then there is the prior Art 102 U.S. Pat. No. 5,097,612 issued to Williams in 1992 and entitled “Illuminated traffic control sign”. It presents an illuminated traffic control sign that transforms a conventional passenger automobile into a traffic control vehicle. The body of the sign is formed from a flexible sheet of weather resistant material. The sign is ordinarily stored under the luggage compartment lid of the automobile when not in use and is deployed between the open lid and the lower part of the luggage compartment when in use. The flexible sheet has a horizontal double arrow design formed on it in a color that contrasts with the color of the sheet. Electric light fixtures are attached over the double arrow design to illuminate the design when the fixtures are activated. It fails to match the functions of the Clark device in many ways. Then there is prior Art 103 U.S. Pat. No. 3,594,938 issued to Mosch in 1971 and entitled “Warning Device”. It shows a warning device for vehicles having a rear portion, the device comprised of a rectangular warning sign made of a flexible sheet material having upper and lower edge portions; attachment means are connected to the edge portions for mounting the device to the vehicle. The attachment means are individually removably connected to the rear of said vehicle when the device is being displayed. However it falls far short of providing the functions demonstrated by Clark.

Prior Art 104 U.S. Pat. No. 5,255,464 was issued to Marecek in 1993 and is entitles “Tailgate Sign”. This demonstrates a removably attachable sign for use on a vehicle tailgate. The sign is generally rectangular and made of a flexible, durable material. The sign can contain apertures or cutaway areas for accommodating various hinges and handles commonly found on vehicle tailgates. The tailgate sign is easily secured to a tailgate by means of straps, clips, belts, snaps, hooks, bars, sheaths, or the like. Again the Maracek device fails to have the functional capacity of the Clark invention. Next, prior Art 105 U.S. Pat. No. 5,355,117 issued to Jefferson in 1994 is entitled “Vehicle warning sign”. It provides a warning sign hinge-mounted on the side of a vehicle, for warning motorists against blocking access, as by parking in close proximity, of a wheelchair to a wheelchair lift aboard the vehicle. The sign includes warning indicia and reflectors, and has a distinctive shape. The sign is manually latched to the vehicle side when not in service, and manually released for deployment. Springs urge the sign into the deployed position perpendicular to the vehicle side when not latched in the stowed position. However, it fails to have the functional capacity or simplicity of the Clark apparatus. Next is shown the prior Art 106 U.S. Pat. No. 5,438,780 issued to Winner in 1995 and entitled “Road sign and information display apparatus”. Here is shown a road sign having a message displayed on a soft reflective plastics material which is attached to a net fabric, preferable a PVC plastics. The net material is attached to a frame structure including a first bar connected at one end of the net and a second bar connected at an opposite end of the net. The net is wound around a roller proximate one of the bars. The bars are biased apart by spring biased folding arms. The device thereby can be raised to an open position by the spring force. Further, a hand crank, or a motor, and also a remote control, can be included for manipulation of the sign, such as to a closed position. The Winner device fails to have the functional equivalence of the Clark invention.

Prior Art 107 US Patent Publication #2005/0278998 submitted by Sawhney et. Al. in 2005 and entitled “Rapid dispatch emergency signs” shows an illuminated sign includes a plurality of sections. Each section includes a mesh of conductors having illuminating pixels located at conductor intersections. The mesh is surrounded by a frame connected to the frame of another section. Once frame sections of the display are unfolded, the display can be supported by a structure attached to a car or other vehicle. A support structure for an illuminated display includes a base which is placed on the ground and over which the tire of a vehicle (e.g., a police car) is parked. A column extends from the base, and a display can be attached to the top of that extending column. The support structure can take the form of a collapsible stand having a trunk which is pivotally attached to a base and which contains a telescoping section. It does not match the functionality portrayed by Clark. Prior Art 108 U.S. Pat. No. 6,037,866 was issued to Leibowitz in 2000 and is entitled “Hazard device for a vehicle”. Here is shown a hazard device for a vehicle in which an outwardly rotatable vertical panel attaches to the rear of the vehicle. The vertical panel can extend the entire height of the vehicle. A safety panel attaches to the vertical panel and extends to the ground. The vertical panel and safety panel provide protection to a person inspecting the vehicle. Alternatively, a portable hazard device is provided in which a plurality of foldable panel sections are connected. In the extended position, the portable hazard device has a height substantially the same as the vehicle. In the folded position, the portable hazard device can be transported in a vehicle. It fails to equate with Clark. Prior Art 109 US Patent Publication No. 2002/0005826 was submitted by Pederson in 2002 and is entitled “LED Sign”. It provides a system for displaying an image comprising at least one display apparatus. Each display apparatus including at least one light bar having a plurality of light emitting diodes mounted thereto. At least one support joining each light bar to a rotation mechanism. The rotation mechanism being constructed and arranged to rotate the light bars at a predetermined rate of rotation. The system also includes a controller in electrical communication with each of the plurality of light emitting diodes, and the rotation mechanism of each of the at least one display apparatus. The controller constructed and arranged to control the predetermined rate of rotation and selectively activate the light emitting diodes to produce at least one image capable of being perceived by a viewer. It does not provide all the features and functions provided by the Clark invention.

### SUMMARY OF THE INVENTION

This invention is a multi-purpose tailgate sign device. The preferred embodiment of the multi-purpose tailgate sign device is comprised of: (a) a display system; (b) a means to power and control the display; (c) a means, to interconnect the power and control to the display; and (d) a means to removably mount the display to the tailgate or doors of a vehicle (such as a pick-up truck) whereby the Multi-Purpose Tailgate Sign device is used to safely and quickly deploy a display or signage with a vehicle such as a work truck. An alternative device is one wherein the means to power and control the display is comprised of: (a) a connection to the trailer power receptacle, a vehicle battery, an auxiliary or supplemental battery, a vehicle or supplemental generator/alternator or a power cord and transformer to an alternating current source (residential or commercial); (b) Main Controls (CPU, Circuitry with Inputs—(Keyboard, Phone, Etc.); and alternatively (c) a remote Controller; connections (such as Infrared, wireless, Wire); and a Remote Display (In-Cab, Phone, Etc.) Connect on Remote Display to Main Controller. Another alternative device is one wherein the means, to interconnect the power and control to the display is comprised of: (a) a Wiring/Circuit/Connection to a Trailer Connect receptacle; (b) a Wiring/Connection to the Controls to Power Source; and (c) Means and connections—Controls (Wire or wireless) and Power (Wire} to Display. Finally, a further alternative device is one wherein the means to removably mount the display to the tailgate or doors of a vehicle such as a pick-up truck is comprised of: (a) a top Clamp Component (Adjustable); (b) a bottom Clamp Component (Adjustable); (c) a series of fasteners (nut, bolt, threaded and quick connect); (d) a top Flip—Contains Frame of Display; (e) a frame around Display; (f) protective cover over Display; and (g) cushion Pads.

The newly invented multi-purpose tailgate sign device is for various uses as seen below and may be manufactured at low volumes by very simple means and in high volume production by more complex and controlled systems.

### Objects and Advantages

There are several objects and advantages of the multi-purpose tailgate sign device. There are currently no known tailgate sign or other devices known that are effective at providing the objects of this invention. The device has, for example and not limitation, the following advantages and benefits:

| Item | Advantages |
|---|---|
| 1 | Provides safer environment for the work |
| | crew |
| 2 | Provides fast deployment of signage |
| 3 | Requires no special tooling |
| 4 | Is completely versatile |
| 5 | Has self-contained power from vehicle |
| 6 | Eliminates need for bulky signage |
| 7 | Eliminates need for multiple signage |
| 8 | Provides an LED sign which is formed of a |
| | relatively simple and inexpensive design, |
| | construction, and operation and which |
| | fulfills the intended purpose without fear |
| | of failure or risk of injury to persons |
| | and/or damage to property |
| 9 | allows the user to adjust the color of the |
| | image, character and/or message without |
| | having to make a physical adjustment to the |
| | LED sign |
| 10 | is capable of producing several different |
| | types, patterns and/or combinations of |
| | light signals, images, characters and/or |
| | messages. |

Finally, other advantages and additional features of the present multi-purpose tailgate sign device will be more apparent from the accompanying drawings and from the full description of the device. For one skilled in the art of tailgate and vehicle sign devices, it is readily understood that the features shown in the examples with this product are readily adapted to other types of signage devices.

### DESCRIPTION OF THE DRAWINGS

### Figures

The accompanying drawings, which are incorporated in and constitute a part of this specification, illustrate an embodiment of the device that is preferred. The drawings together with the summary description given above and a detailed description given below serve to explain the principles of the Multi-Purpose Tailgate Sign device. It is understood, however, that the multi-purpose tailgate sign device is not limited to only the precise arrangements and instrumentalities shown.

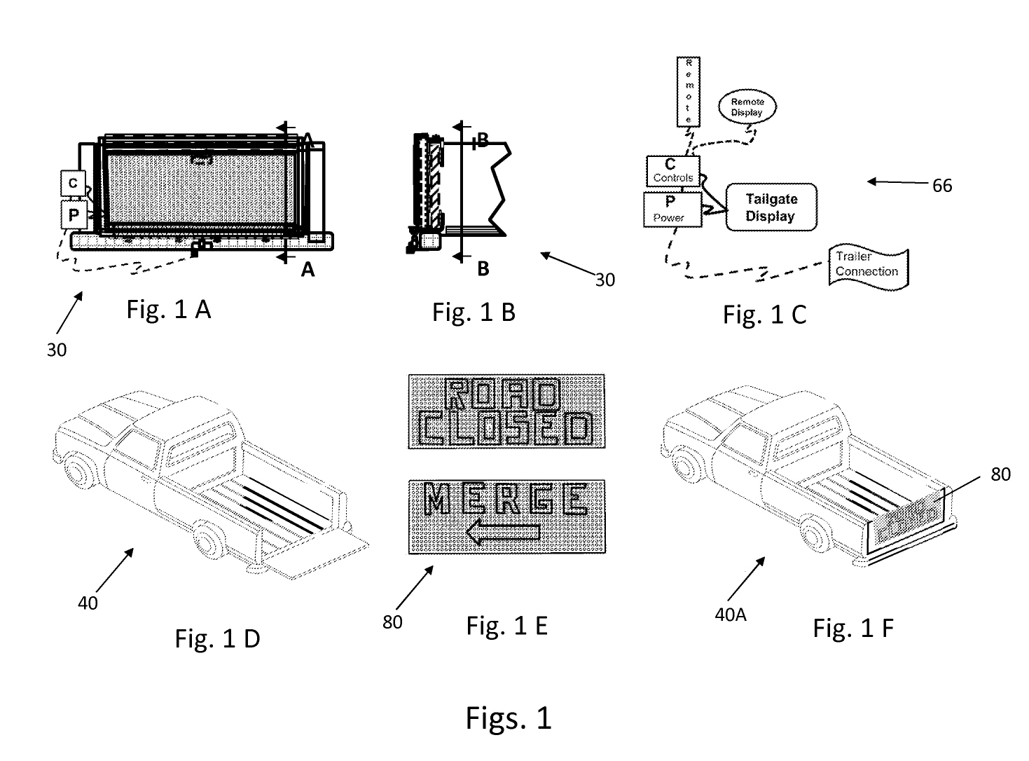

FIGS. 1 A through 1 F are the general configurations of the multi-purpose tailgate sign device.

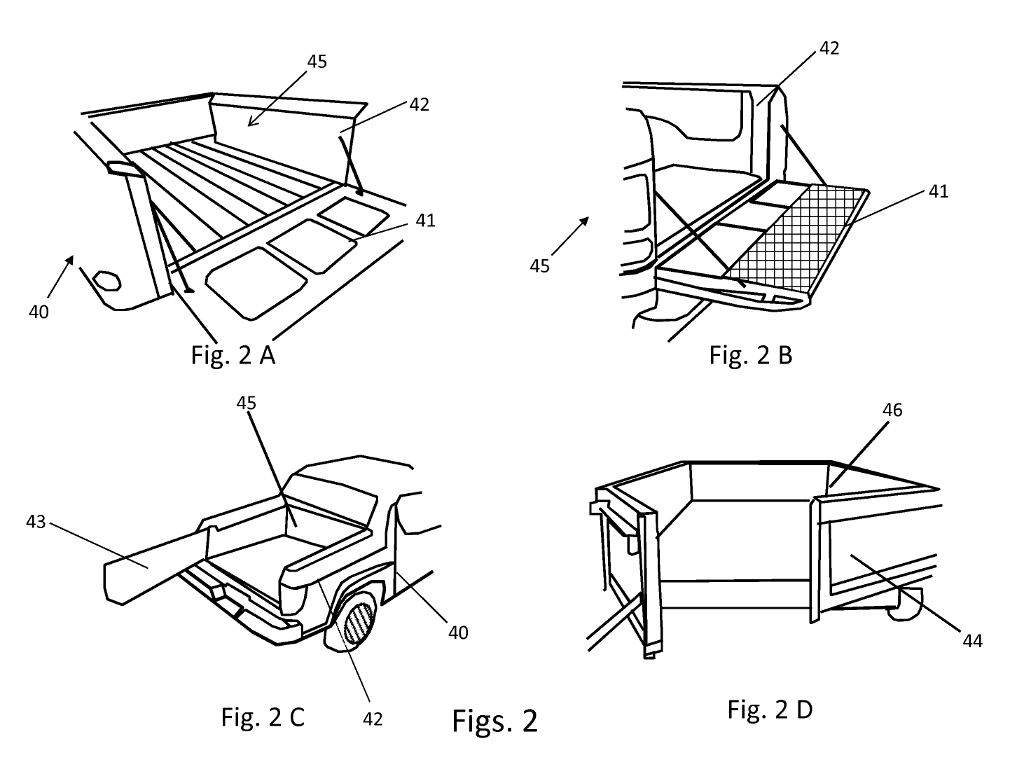

FIGS. 2 A through 2 D are examples of tailgate configurations for stand and pick-up trucks and trailers.

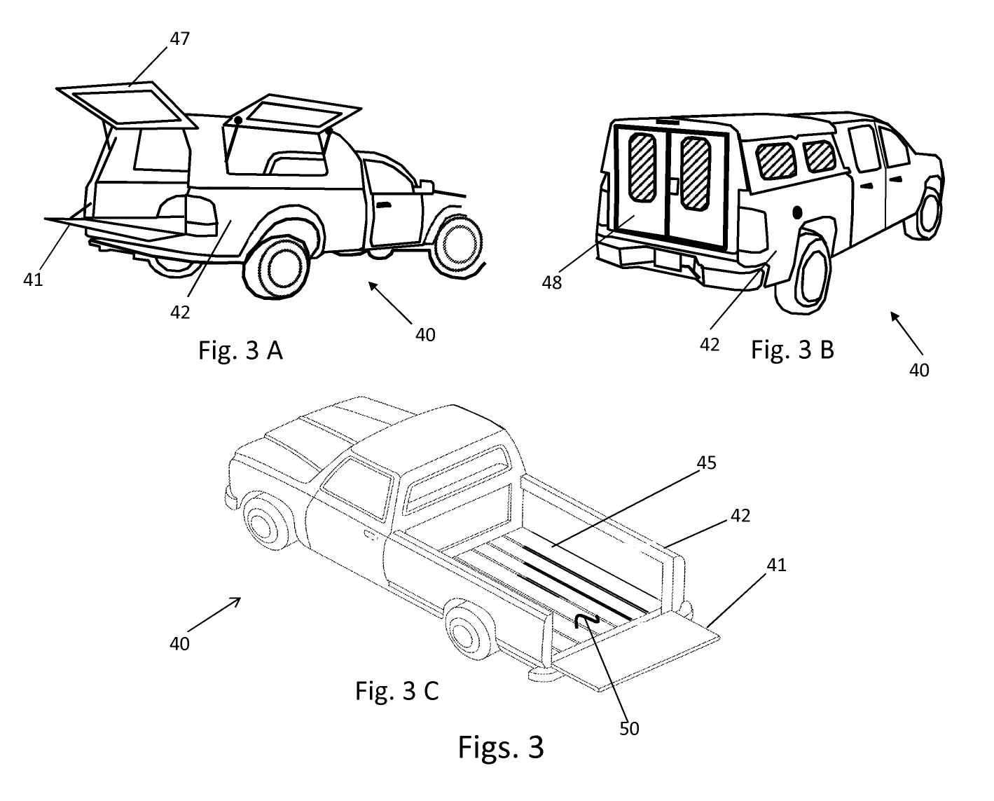

FIGS. 3 A through 3 C are more examples of typical tailgate configurations for vehicles

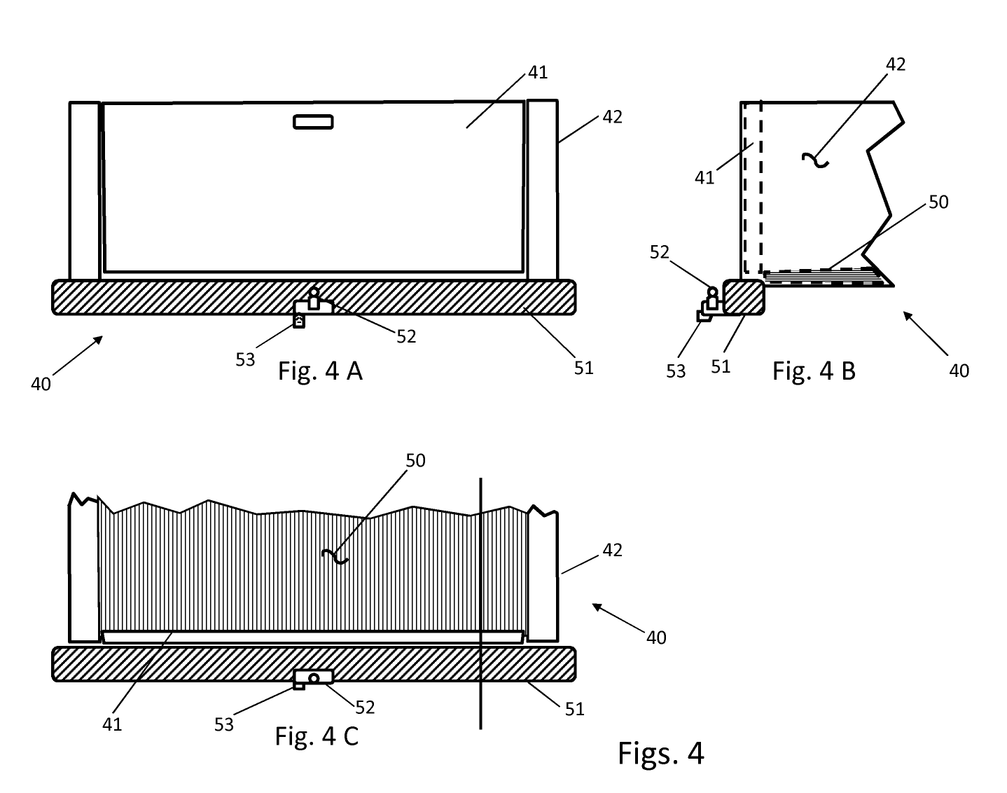

FIGS. 4 A through 4 C are sketches of a basic drop down tailgate for a pick-up truck

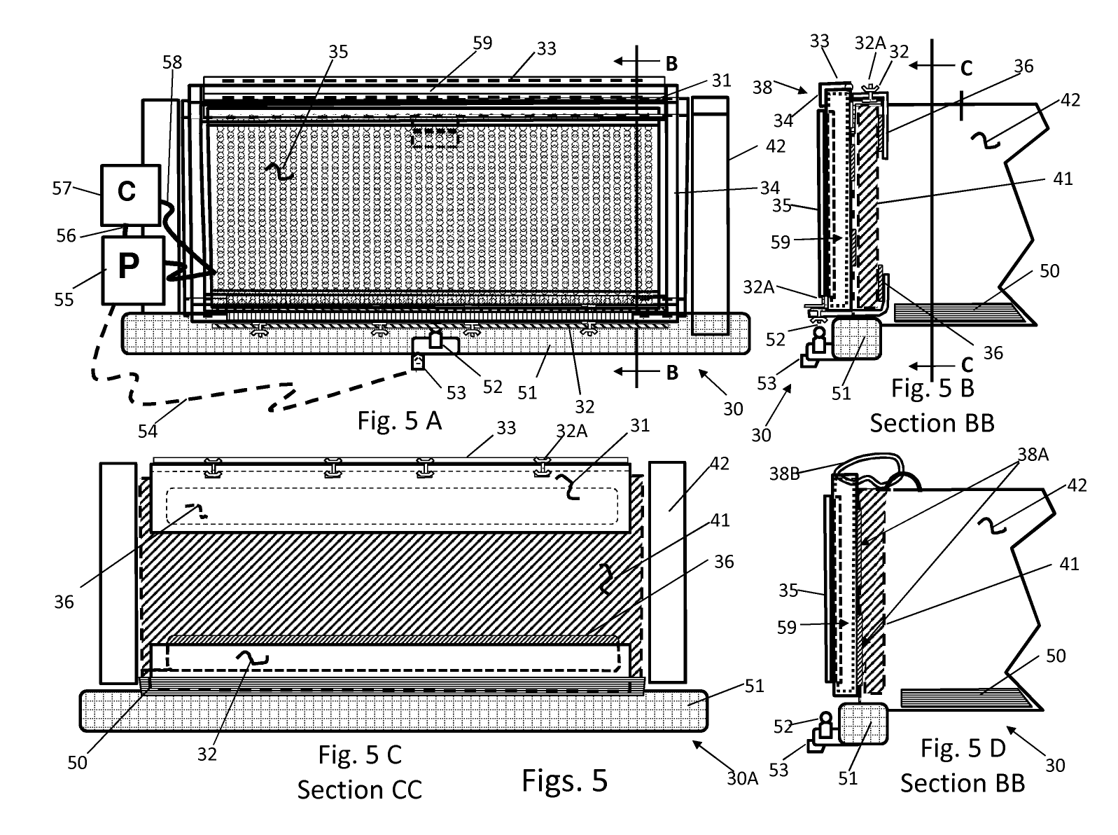

FIGS. 5 A through 5 D are sketches of the multi-purpose tailgate sign device mounted on the tailgate of a pick-up truck.

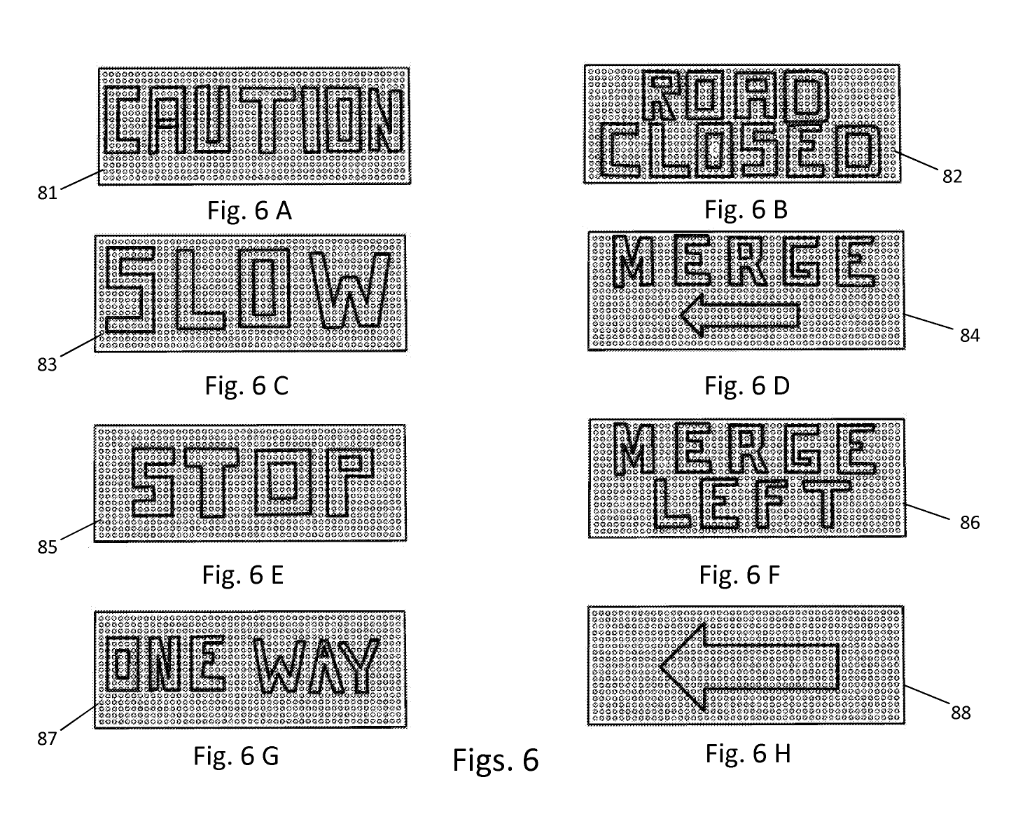

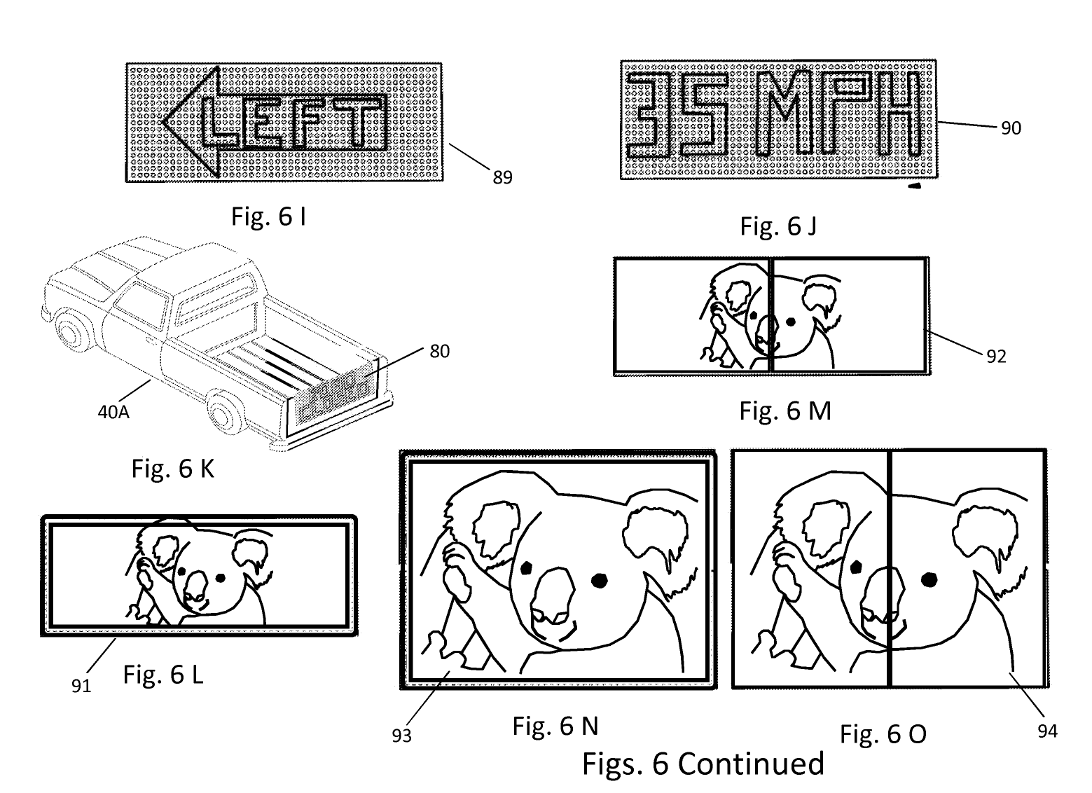

FIGS. 6 A through 6 O are samples of the types of communication and display available with the multi-purpose tailgate sign device.

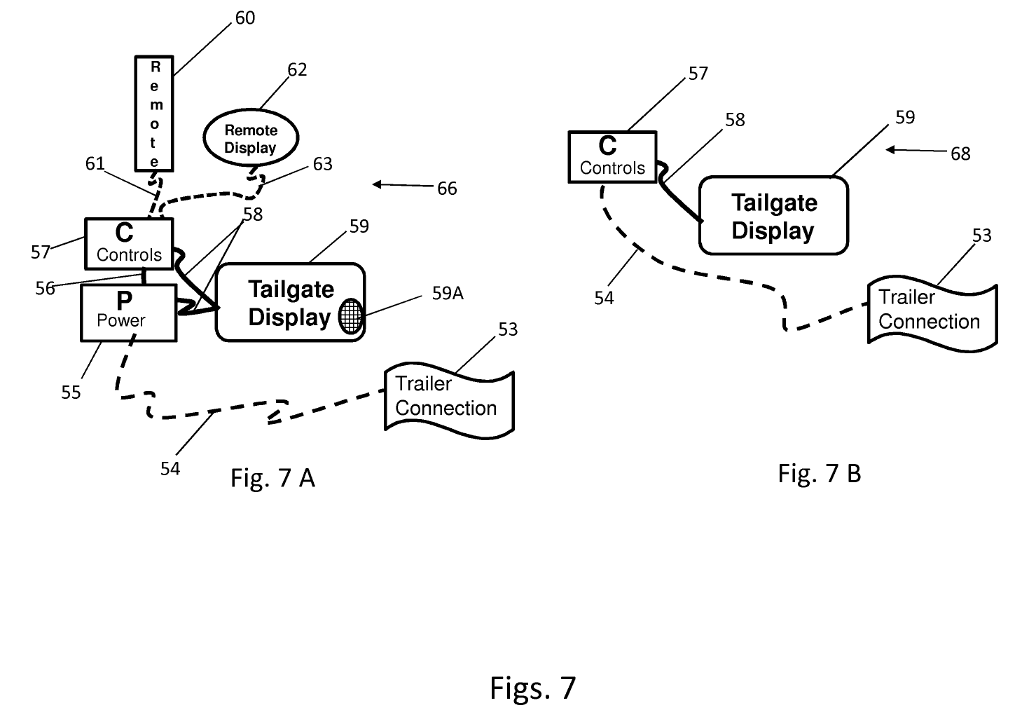

FIGS. 7 A and 7 B are control diagrams for the multi-purpose tailgate sign device.

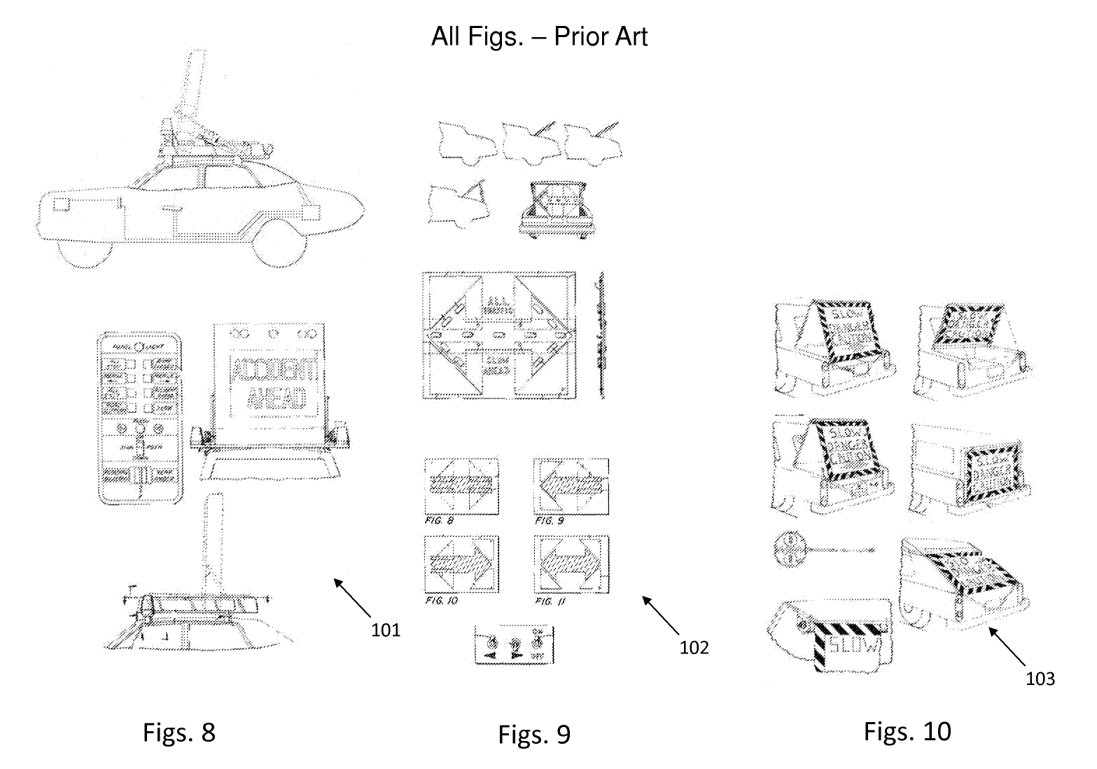

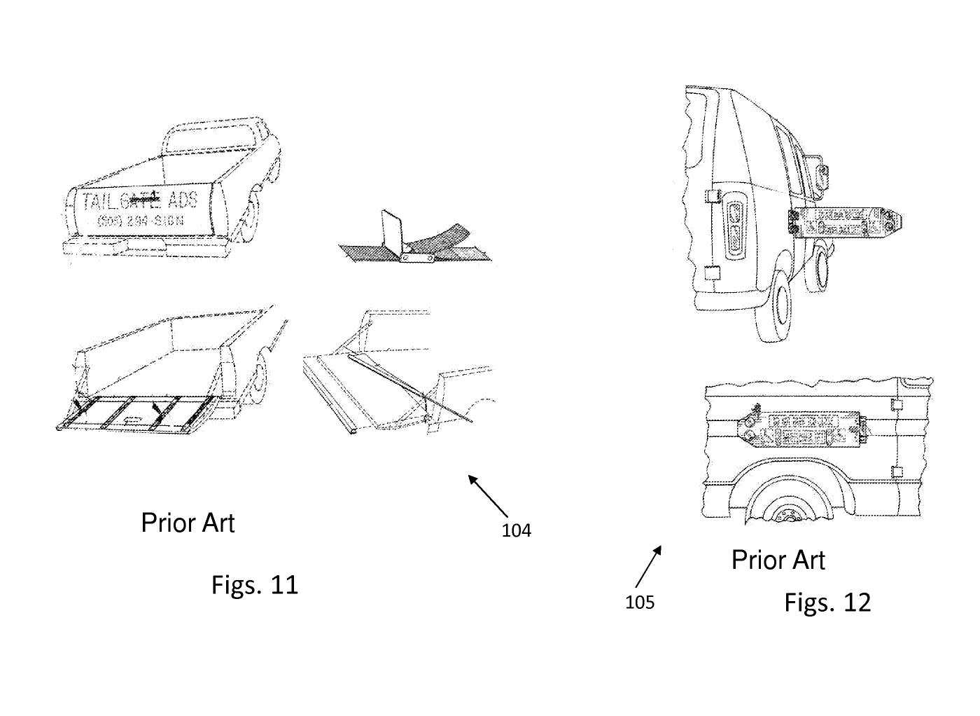

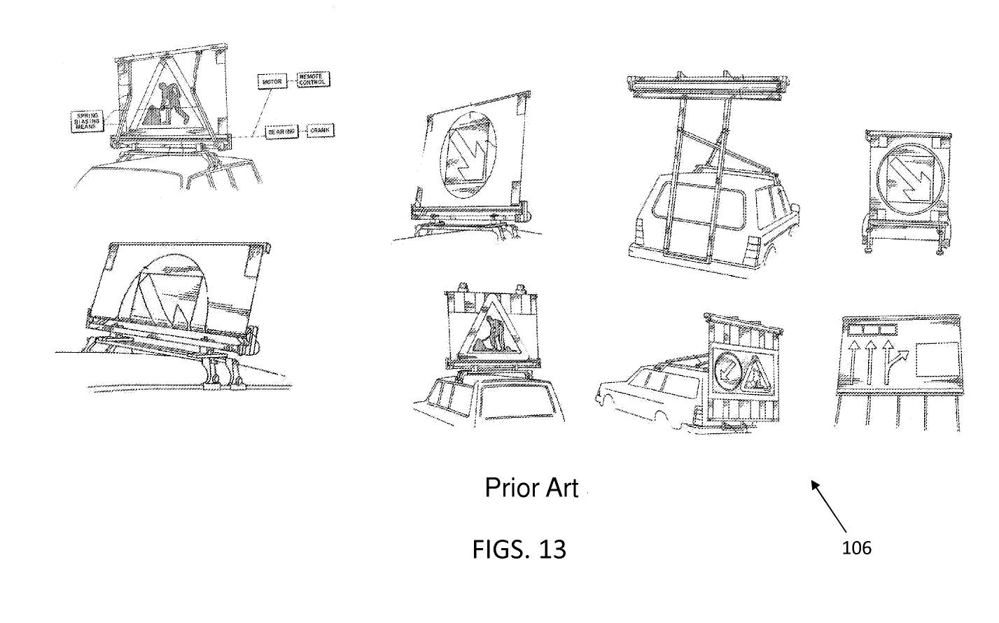

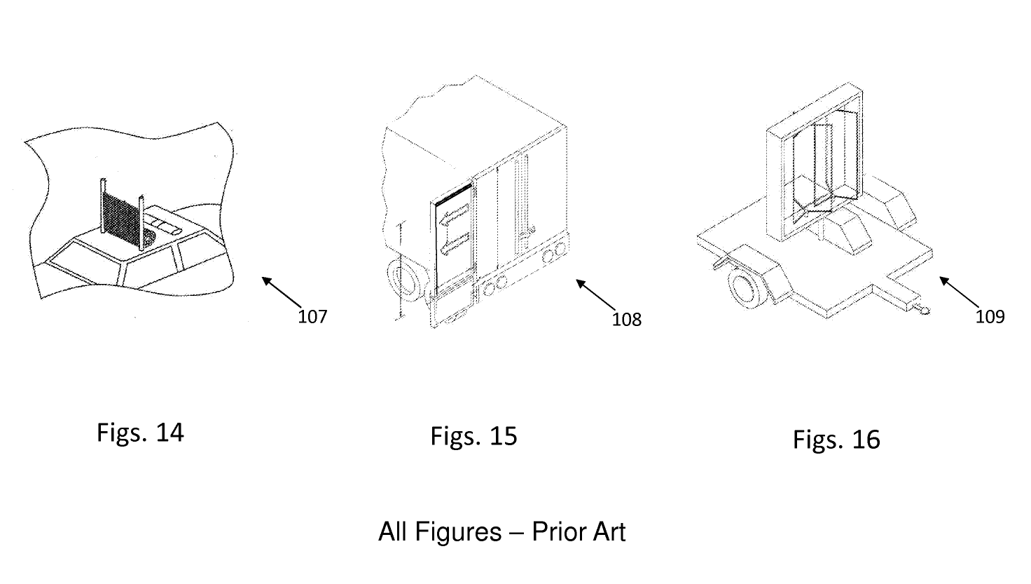

FIGS. 8 through 16 are prior art sign devices that support the position that the Clark Multi-Purpose Sign Device is a unique and patentable invention.

### DESCRIPTION OF THE DRAWINGS

### Reference Numerals

The following list refers to the drawings:

TABLE A
Reference numbers

| Ref | |
|---|---|
| # | Description |
| 30 | Multi-Purpose Tailgate Sign Device |
| 30A | Inside Bed View Of Multi-Purpose Tailgate Sign Device |
| 31 | Top Clamp Component (Adjustable) |
| 32 | Bottom Clamp Component (Adjustable) |
| 32A | Fasteners (nut, bolt, threaded and quick connect) |
| 33 | Top Flip - Contains Frame of Display |
| 34 | Frame around Display 59 |
| 35 | Protective cover over Display 59 |
| 36 | Cushion Pads |
| 38 | a means 38 to removably mount the display 59 to the tailgate |
| | 41 or doors of a vehicle such as a pick-up truck 40 |
| 38A | Means for securing - adhesive or high strength magnets |
| 38B | Safety cable and truck eyelet |
| 40 | Pick-Up Truck |
| 40A | Pick-Up Truck with Signage |
| 41 | Drop Down Gate |
| 42 | Sides of Pick-Up Truck Bed |
| 43 | Side Swing Gate |
| 44 | Double Gate |
| 45 | Pick-Up Truck Bed |
| 46 | Trailer |
| 47 | Flip Up Rear Window |
| 48 | Dual Side Swing Doors |
| 49 | |
| 50 | Floor of Bed |
| 51 | Bumper |
| 52 | Hitch |
| 53 | Electrical Connection for Trailer, or the like |
| 54 | Wiring/Circuit/Connection to Trailer Connect |
| 54A | a means 54A to interconnect the power 55 and control 56 to |
| | the display 59; |
| 55 | Power Source - connection to the trailer power receptacle 53, |
| | a vehicle battery, an auxiliary or supplemental battery, a |
| | vehicle or supplemental generator/alternator or a power cord |
| | and transformer to an alternating current source (residential |
| | or commercial) |
| 56 | Wiring/Connection Controls to Power Source |
| 57 | Main Controls (CPU, Circuitry with Inputs - (Keyboard, Phone, |
| | Etc.) |
| 58 | Means and connections Connections 58 - Controls (Wire or |
| | wireless) and Power (Wire} to Display |
| 59 | Display (Video and Audio) |
| 59A | Audio systems and amplifiers |
| 60 | Remote Controller |
| 61 | Remote 60 to Main Controller 57 Connection (Infrared, |
| | wireless, Wire) |
| 62 | Remote Display (In-Cab, Phone, Etc.) |
| 63 | Connect on Remote Display 62 to Main Controller 57 |
| 64 | a means 64 to interconnect the power 55 and control 56 to |
| | the display 59; |
| 66 | Full control and power system block diagram to multi-purpose |
| | tailgate system |
| 68 | Simplified control and power system block diagram to multi- |
| | purpose tailgate system |
| 80 | Typical Signage |
| 81 | Caution Sign |
| 82 | Road Closed Sign |
| 83 | Slow Sign |
| 84 | Merge Signal |
| 85 | Stop Alert |
| 86 | Merge Left Signage |
| 87 | One Way Signage |
| 88 | Arrow Signage |
| 89 | Left Arrow Signage |
| 90 | Speed Limit Signage |
| 91 | Computer Screen Display |
| 92 | Split Gate Computer Screen Display |
| 93 | Large Panel Display |
| 94 | Split Door for Large Panel Display |
| 101 | Prior Art U.S. Pat. No. 3,761,890 |
| 102 | Prior Art U.S. Pat. No. 5,097,612 |
| 103 | Prior Art U.S. Pat. No. 3,594,938 |
| 104 | Prior Art U.S. Pat. No. 5,255,464 |
| 105 | Prior Art U.S. Pat. No. 5,355,117 |
| 106 | Prior Art U.S. Pat. No. 5,438,780 |
| 107 | Prior Art US Patent Publication # 2005/0278998 |
| 108 | Prior Art U.S. Pat. No. 6,037,866 |
| 109 | Prior Art US Patent Publication # 2002/0005826 |

### DETAILED DESCRIPTION OF PREFERRED EMBODIMENT

The present development is a multi-purpose tailgate sign device that is related to a road sign and information display apparatus which may be deployed as an improved safety warning device for vehicles. The apparatus becomes temporarily effective when the vehicle stands on the road in the way of other vehicles.

Taught here are the ways that a multi-purpose tailgate sign device may have a plurality of multi-colored light emitting diodes (LEDs) or another visual display system for signage and visual communication. It is a unique device which, as an illuminated sign, can be rapidly deployed in response to relatively quickly changing conditions and used for many uses such as traffic control. The device relates to removable structures which can be used to support such signs and displays from vehicles such as pick-up truck tailgates.

The advantages for the a multi-purpose tailgate sign device 30 are listed above in the introduction. Succinctly the benefits are that the device:
Provides safer environment for the work crew;
Provides fast deployment of signage;
Requires no special tooling;
Is completely versatile;
Has self-contained power from vehicle;
Eliminates need for bulky signage;
Eliminates need for multiple signage
Provides an LED sign which is formed of a relatively simple and inexpensive design, construction, and operation and which fulfills the intended purpose without fear of failure or risk of injury to persons and/or damage to property;
Allows the user to adjust the color of the image, character and/or message without having to make a physical adjustment to the LED sign; and
Is capable of producing several different types, patterns and/or combinations of light signals, images, characters and/or messages.

The preferred embodiment of the a multi-purpose tailgate sign device is comprised of: (a) a display system 59; (b) a means 64 to power and control the display 59; (c) a means 54A, to interconnect the power 55 and control 56 to the display 59; and (d) a means 38 to removably mount the display 59 to the tailgate 41 or doors of a vehicle (such as a pick-up truck 40) whereby the Multi-Purpose Tailgate Sign device 30 is used to safely and quickly deploy a display or signage with a vehicle such as a work truck. An alternative device is one wherein the means 64 to power and control the display 59 is comprised of: (a) a connection to the trailer power receptacle 53, a vehicle battery, an auxiliary or supplemental battery, a vehicle or supplemental generator/alternator or a power cord and transformer to an alternating current source (residential or commercial); (b) Main Controls 57 (CPU, Circuitry with Inputs—(Keyboard, Phone, Etc.); and alternatively (c) a remote Controller 60; connections 61 (such as Infrared, wireless, Wire); and a Remote Display 62 (In-Cab, Phone, Etc.) Connect 63 on Remote Display 62 to Main Controller 57. Another alternative device is one wherein the means 54A, to interconnect the power 55 and control 56 to the display 59 is comprised of: (a) a Wiring/Circuit/Connection 54 to a Trailer Connect receptacle 53; (b) a Wiring/Connection 56 to the Controls 57 to Power Source 55; and (c) Means and connections 58—Controls (Wire or wireless) and Power (Wire} to Display. Finally, a further alternative device is one wherein the means 38 to removably mount the display 59 to the tailgate 41 or doors of a vehicle such as a pick-up truck 40 is comprised of: (a) a top Clamp Component (Adjustable) 31; (b) a bottom Clamp Component (Adjustable) 32; (c) a series of fasteners (nut, bolt, threaded and quick connect) 32A; (d) a top Flip—Contains Frame of Display 33; (e) a frame 34 around Display 59; (f) protective cover 35 over Display 59; and (g) cushion Pads 36.

There is shown in FIGS. 1-16 a complete description and operative embodiment of the multi-purpose tailgate sign device. In the drawings and illustrations, one notes well that the FIGS. 1-16 demonstrate the general configuration and use of this product. The various example uses are in the operation and use section, below.

The accompanying drawings, which are incorporated in and constitute a part of this specification, illustrate an embodiment of the multi-purpose tailgate sign device 30 that is preferred. The drawings together with the summary description given above and a detailed description given below serve to explain the principles of the multi-purpose tailgate sign device 30. It is understood, however, that the multi-purpose tailgate sign device 30 is not limited to only the precise arrangements and instrumentalities shown. Other examples of tailgate sign devices and uses are still understood by one skilled in the art of tailgate and multi-purpose signs (and like devices) to be within the scope and spirit shown here.

FIGS. 1 A through 1 F are the general configurations of the multi-purpose tailgate sign device. Demonstrated are the Multi-Purpose Tailgate Sign Device 30, the full control and power system block diagram 66 to multi-purpose tailgate system 30; pick-up truck 40; a typical sign 80; and a pick-up truck with signage 40A. The sketches are a generally side or perspective view. Components and details are shown in other drawings and explained below.

FIGS. 2 A through 2 D are examples of tailgate configurations for standard pick-up trucks and trailers. Demonstrated are a pick-up truck 40, a drop down gate 41, sides of pick-up truck bed 42, the Trailer 46, side swing gate 43, double gate 44, and pick-up truck bed 45.

FIGS. 3 A through 3 C are more examples of typical tailgate configurations for vehicles. These include the pick-up truck 40, a drop down gate 41, sides of pick-up truck bed 42, side swing gate 43, double gate 44, and pick-up truck bed 45. Also shown are a flip up rear window 47, Floor of Bed 50 and a dual side swing doors 48.

FIGS. 4 A through 4 C are sketches of a basic drop down tailgate for a pick-up truck 40, a drop down gate 41, sides of pick-up truck bed 42, floor of bed 50, bumper 51, hitch 52 and an electrical connection 53 for pulling a trailer, or the like.

FIGS. 5 A through 5 D are sketches of the multi-purpose tailgate sign device mounted on the tailgate of a pick-up truck. Seen in FIGS. 5 A through 5 C is a removable clamp system. Seen here are the top clamp component (adjustable) 31, the bottom clamp component (adjustable) 32, a series of fasteners (nut, bolt, threaded and quick connect clips) 32A a top flip—the component 33 contains the frame 34 of display 59, a frame 34 around Display 59, a protective cover 35 over display 59 and one or more cushion pads 36 to separate the truck tailgate 41 from the display 59 and frame 34. The frame 34 and flip down 33 create a holding bracket for the display 59. Also shown are the drop down gate 41, sides of pick-up truck bed 42, floor of bed 50, bumper 51, hitch 52 and an electrical connection 53 for pulling a trailer, or the like. The controller 57, the power source 55 and the various means to interconnect 54, 56, and 58, are further discussed below in the details about FIG. 7. Seen in FIG. 5 D is an alternative embodiment of a more rigorous and less removable attachment system. In FIG. 5 D is shown an alternative means for securing 38A—adhesive or high strength magnets—the display 59 and frame 34 to the tailgate 41. Also, a safety cable and truck eyelet 38B is attached between the frame 34 and the truck sides 42 as a precaution if the adhesive or magnets 38A are jarred loose or become detached from the tailgate 41. Anticipated for the alternative attachment 38A is an adhesive material such as a two part bonding epoxy resin and filler or another compound with aerobic or thermal curing. The magnetic system is comprised of high strength magnets like samarium cobalt, neodymium or equally high strength magnets. Naturally, the tailgate would need to be a ferrous material or have a ferrous plate securely attached to the surface of the tailgate 41 to receive the magnets 38A.

All of the frame material may be comprised of a metal such as steel or aluminum and may be coated with a powder coat, paint, or other surface finish such as chrome or galvanized coatings. The components may also be made of a heavy duty, durable plastic or composite material. The configuration of the components may be from a plethora of designs such as a “ZEE” cross section, Channel “C”, or other structural shapes such as tees (T), angles (L), or beams types (H or I). The display 59 is discussed below. The cushion pad are a shock absorbing material such as closed cell urethane, rubber, neoprene, thick fabric, composite materials, or the like. The protective cover 35 over the display 59 anticipates a transparent and non-breakable high strength plastic or Lexan™ type sheet or the like.

The display 59 may of several types.

A. One may be an illuminated sign with a single or a plurality of sections. Each section includes a mesh of conductors having illuminating pixels located at conductor intersections. The mesh is surrounded by a frame connected to the frame of another section. Such a display might be comprising: a section, including a plurality of light-emitting pixels, a mesh of conductors having a plurality of conductor intersections, each intersection of the first plurality having one of the first plurality of pixels situated thereon, and a frame supporting the first mesh and surrounding at least a portion thereof; and a second or more plurality of similar sections wherein the sections are removably attached to the tailgate or doors as described above and shown in the accompanying drawings.
B. Another may be a LED arrangement for use in displaying the message or warning. A light emitting diode (LED) sign having capabilities to generate a warning signal light and blinking/intermittent/pulsed light communication system which may be depicted in several embodiments. In general, the LED sign and pulsed light communication system may be formed of a single row and column, single source, or an array of light emitting diode light sources configured on a light support and in electrical communication with a controller and a power supply, battery, or other electrical source. The LED sign and pulsed light communication system may provide various images, light signals, colored light signals, or combination light signals. These images or light signals may include images, characters, messages, a strobe light, a pulsating light, a flashing light, a modulated or variable intensity light, an oscillating light, an alternating light, an encoded signal, and/or various patterns or combinations thereof. Pulsed light communication system and LED sign may also be transportable and may be removably secured to the tailgates or doors of the vehicle/truck/pickup as a remote stand-alone signaling or communication device.
C. Another example and not shown as a limitation to the spirit and scope of the Clark multi-purpose tailgate sign device is a flat, video display unit such as used for medium and large screened television and computer displays or the like.
In all the above examples, the full device may also be equipped with audio systems 59A and amplifiers if desired for specific uses or needs.

FIGS. 6 A through 6 O are samples of the types of communication and display available with the multi-purpose tailgate sign device. These are detailed below in the operation section.

FIGS. 7 A and 7 B are control diagrams for the multi-purpose tailgate sign device. The anticipated embodiment of the components and parts for the power and control system of the multi-purpose tailgate sign devices are shown in the full control and power system block diagram 66 and the simplified control and power system block diagram 68 to multi-purpose tailgate system 30. Here are demonstrated for a display system 59 a means 64 to power and control the display 59; a means 54A, to interconnect the power 55 and control 56 to the display 59; and a means 38 to removably mount the display 59 to the tailgate 41 or doors of a vehicle (such as a pick-up truck 40). Additional embodiments include the means 64 to power and control the display 59 being comprised of—a connection to the trailer power receptacle 53, a vehicle battery, an auxiliary or supplemental battery, a vehicle or supplemental generator/alternator or a power cord and transformer to an alternating current source (residential or commercial)—a set of Main Controls 57 (CPU, Circuitry with Inputs—(Keyboard, Phone, Etc.); and alternatively a remote Controller 60; connections 61 (such as Infrared, wireless, Wire); and a Remote Display 62 (In-Cab, Phone, Etc.) Connect 63 on Remote Display 62 to Main Controller 57. Further shown in the diagrams 66, 68 are wherein the means 54A, to interconnect the power 55 and control 56 to display 59 is comprised of a Wiring/Circuit/Connection 54 to a Trailer Connect receptacle 53; a Wiring/Connection 56 to the Controls 57 to Power Source 55; and a means and connections 58—Controls (Wire or wireless) and Power (Wire} to the display 59.

Other features for a LED sign is having a controller that has a processor programmed for the performance of a handshake protocol during the transmission and/or receipt of a pulsed light signal used to communicate information. Other options for the control are anticipated such as a light emitting diode (LED) sign having capabilities be in electrical communication with a controller and a power supply, battery, or other electrical source. The LED sign may provide the various images, signals and displays as a communication system that is electrically coupled to a controller which is used to vary, modulate, pulse, or encode the power intensity for the LED light sources to provide for various patterns of illumination to create an image, message or signal. The LED light system as a portion of the LED sign may also include a receptor coupled to the controller where the receptor is constructed and arranged for receipt of pulsed LED light signals for conversion to digital information for transfer to the controller for analysis and interpretation. The controller may then illuminate an image, message, or character to provide a light signal. An LED sign according to various embodiments of the invention described can be constructed using any of the various methods, structures, and materials.

FIGS. 8 through 16 are prior art sign devices that support the position that the newly invented Clark Multi-Purpose Sign Device is a unique and patentable invention. Shown are the following: Prior Art 101 U.S. Pat. No. 3,761,890; Prior Art 102 U.S. Pat. No. 5,097,612; Prior Art 103 U.S. Pat. No. 3,594,938; Prior Art 104 U.S. Pat. No. 5,255,464; Prior Art 105 U.S. Pat. No. 5,355,117; Prior Art 106 U.S. Pat. No. 5,438,780; Prior Art 107 US Patent Publication No. 2005/0278998; Prior Art 108 U.S. Pat. No. 6,037,866; and Prior Art 109 US Patent Publication No. 2002/0005826.

The details mentioned here are exemplary and not limiting. Other specific components and manners specific to describing a multi-purpose tailgate sign device 30 may be added as a person having ordinary skill in the field of signage devices and their uses well appreciates.

### Operation of the Preferred Embodiment

The multi-purpose tailgate sign device 30 has been described in the above embodiment. The manner of how the device operates is described below. One notes well that the description above and the operation described here must be taken together to fully illustrate the concept of the multi-purpose tailgate sign device 30. The preferred embodiment of the a multi-purpose tailgate sign device is comprised of: (a) a display system 59; (b) a means 64 to power and control the display 59; (c) a means 54A, to interconnect the power 55 and control 56 to the display 59; and (d) a means 38 to removably mount the display 59 to the tailgate 41 or doors of a vehicle (such as a pick-up truck 40) whereby the Multi-Purpose Tailgate Sign device 30 is used to safely and quickly deploy a display or signage with a vehicle such as a work truck. An alternative device is one wherein the means 64 to power and control the display 59 is comprised of: (a) a connection to the trailer power receptacle 53, a vehicle battery, an auxiliary or supplemental battery, a vehicle or supplemental generator/alternator or a power cord and transformer to an alternating current source (residential or commercial); (b) Main Controls 57 (CPU, Circuitry with Inputs—(Keyboard, Phone, Etc.); and alternatively (c) a remote Controller 60; connections 61 (such as Infrared, wireless, Wire); and a Remote Display 62 (In-Cab, Phone, Etc.) Connect 63 on Remote Display 62 to Main Controller 57. Another alternative device is one wherein the means 54A, to interconnect the power 55 and control 56 to the display 59 is comprised of: (a) a Wiring/Circuit/Connection 54 to a Trailer Connect receptacle 53; (b) a Wiring/Connection 56 to the Controls 57 to Power Source 55; and (c) Means and connections 58—Controls (Wire or wireless) and Power (Wire} to Display. Finally, a further alternative device is one wherein the means 38 to removably mount the display 59 to the tailgate 41 or doors of a vehicle such as a pick-up truck 40 is comprised of: (a) a top Clamp Component (Adjustable) 31; (b) a bottom Clamp Component (Adjustable) 32; (c) a series of fasteners (nut, bolt, threaded and quick connect) 32A; (d) a top Flip—Contains Frame of Display 33; (e) a frame 34 around Display 59; (f) protective cover 35 over Display 59; and (g) cushion Pads 36.

The multi-purpose tailgate sign device 30 operates by placing the display 59 onto the tailgate 41 as shown in the FIGS. 4 and 5 as described above. The electrical means and connections shown in Figured 5 and 7 are then connected to the power and controls as shown. One skilled in vehicle and electronic connection well appreciates this is within the ordinary skill of most vehicle operators with trailer hitches and other electrical and electronic components. Finally, the Multi-Purpose Tailgate Sign Device 30 is controlled from the control panel, keyboard, phone or other signals to the controller 57. This may be through a hard-wired connection or wireless/remote means.

There are many uses are anticipated for the multi-purpose tailgate sign device 30. Some examples, and not limitations, are shown in the following Table.

| ITEM | DESCRIPTION |
|---|---|
| 1 | Road and municipal crew work where signs |
| | and alerts are needed for a safe work |
| | environment |
| 2 | Mowing, trash and trimming crews |
| 3 | Outdoor concert communication |
| 4 | Instruction videos |
| 5 | Emergency and disaster relief |
| 6 | School events |
| 7 | Construction vehicles |
| 8 | Military and Homeland security vehicles |
| 9 | Crowd control at large events |

These uses may be expanded by noting that there are a variety of roadway or emergency situations have occurred over recent years that underscore the need for Rapid Dispatch Emergency Signs (RDES) or Rapid Dispatch Incident Management Signs (RDIMS) that get highly visible messaging to critical places quickly. Examples of such situations include traffic problems and road construction, as well as much more serious occurrences (e.g., the terrorist attacks of Sep. 11, 2001, the New York blackout, the Southern California fires, etc.). In all of these situations, authorities need to advise large groups of people where to go, what to do, etc. An illuminated sign or other display is often an ideal way to provide such information. If authorities can quickly move a portable illuminated display to where it is needed, hazardous or potentially hazardous situations can be better addressed. In addition, signs according to various embodiments of the invention can be used by, e.g., law enforcement agencies and emergency management service departments around the country. Embodiments of the invention can be deployed widely and strategically in the case of major emergency, as well as quickly and accurately when faced with interruptions to standard traffic flow. The existence of these signs in multiple vehicles as standard equipment greatly increases the chance that motorists and/or pedestrians can be quickly routed as appropriate.

Further, to minimize set up time for rapid dispatch, several forms of interconnection are possible, including power, signal (including wireless), and mechanical. For example, the sign can be integrated with a cruiser's onboard computer and communications; text for messages can be entered using existing data entry equipment, or text can be updated from headquarters using existing radio/data interface. Sound can be synchronized with the display to reinforce or supplement the text messages, and routed through existing external speakers. Power can be drawn from existing power bus on the vehicle or through a cigarette lighter-style connection.

Finally, for routine roadwork, or situations where a variety of motorists need to be informed of an emergency that affects multiple exits and/or intersections, the signs would require only a single vehicle to deliver quickly deployed signs along a route or group of routes.

FIGS. 6 A through 6 O are samples of the types of communication and display available with the multi-purpose tailgate sign device. The typical examples (and not as a limitation for types of symbols, words, or displays) include [in the drawings denoted FIG. 6 “LTR”] for Typical Signage 80 as follows:
A. Caution Sign 81,
B. Road Closed Sign 82,
C. Slow Sign 83,
D. Merge Signal 84,
E. Stop Alert 85,
F. Merge Left Signage 86,
G. One Way Signage 87,
H. Arrow Signage 88,
I. Left Arrow Signage 89,
J. Speed Limit Signage 90,
K. Typical truck 40A with signage 80,
L. Computer Screen Display 91,
M. Split Gate Computer Screen Display 92,
N. Large Panel Display 93, and
O. Split Door for Large Panel Display 94.

With this description it is to be understood that the multi-purpose tailgate sign device 30 is not to be limited to only the disclosed embodiment of product. The features of the multi-purpose tailgate sign device 30 are intended to cover various modifications and equivalent arrangements included within the spirit and scope of the description.

While certain novel features of this invention have been shown and described and are pointed out in the annexed claims, it is not intended to be limited to the details above, since it will be understood that various omissions, modifications, substitutions and changes in the forms and details of the device illustrated and in its operation can be made by those skilled in the art without departing in any way from the spirit of the present invention. Without further analysis, the foregoing will so fully reveal the gist of the present invention that others can, by applying current knowledge, readily adapt it for various applications without omitting features that, from the standpoint of prior art, fairly constitute essential characteristics of the generic or specific aspects of this invention.

Unless defined otherwise, all technical and scientific terms used herein have the same meaning as commonly understood by one of ordinary skill in the art to which these inventions belong. Although any methods and materials similar or equivalent to those described herein can also be used in the practice or testing of the present inventions, the preferred methods and materials are now described above in the foregoing paragraphs.

Other embodiments of the invention are possible. Although the description above contains much specificity, these should not be construed as limiting the scope of the invention, but as merely providing illustrations of some of the presently preferred embodiments of this invention. It is also contemplated that various combinations or sub-combinations of the specific features and aspects of the embodiments may be made and still fall within the scope of the inventions. It should be understood that various features and aspects of the disclosed embodiments can be combined with or substituted for one another in order to form varying modes of the disclosed inventions. Thus, it is intended that the scope of at least some of the present inventions herein disclosed should not be limited by the particular disclosed embodiments described above.

The terms recited in the claims should be given their ordinary and customary meaning as determined by reference to relevant entries (e.g., definition of “plane” as a carpenter's tool would not be relevant to the use of the term “plane” when used to refer to an airplane, etc.) in dictionaries (e.g., widely used general reference dictionaries and/or relevant technical dictionaries), commonly understood meanings by those in the art, etc., with the understanding that the broadest meaning imparted by any one or combination of these sources should be given to the claim terms (e.g., two or more relevant dictionary entries should be combined to provide the broadest meaning of the combination of entries, etc.) subject only to the following exceptions: (a) if a term is used herein in a manner more expansive than its ordinary and customary meaning, the term should be given its ordinary and customary meaning plus the additional expansive meaning, or (b) if a term has been explicitly defined to have a different meaning by reciting the term followed by the phrase “as used herein shall mean” or similar language (e.g., “herein this term means,” “as defined herein,” “for the purposes of this disclosure [the term] shall mean,” etc.). References to specific examples, use of “i.e.,” use of the word “invention,” etc., are not meant to invoke exception (b) or otherwise restrict the scope of the recited claim terms. Other than situations where exception (b) applies, nothing contained herein should be considered a disclaimer or disavowal of claim scope. Accordingly, the subject matter recited in the claims is not coextensive with and should not be interpreted to be coextensive with any particular embodiment, feature, or combination of features shown herein. This is true even if only a single embodiment of the particular feature or combination of features is illustrated and described herein. Thus, the appended claims should be read to be given their broadest interpretation in view of the prior art and the ordinary meaning of the claim terms.

Unless otherwise indicated, all numbers or expressions, such as those expressing dimensions, physical characteristics, etc. used in the specification (other than the claims) are understood as modified in all instances by the term “approximately.” At the very least, and not as an attempt to limit the application of the doctrine of equivalents to the claims, each numerical parameter recited in the specification or claims which is modified by the term “approximately” should at least be construed in light of the number of recited significant digits and by applying ordinary rounding techniques.

What is claimed is:

1. A multi-purpose tailgate sign device comprised of:
(a) a display system (59);
(b) a means (64) to power and control the display (59);
(c) a means (54A) to interconnect the power (55) and control (56) to the display (59); and
(d) a means (38) to removably mount the display (59) to the tailgate (41) and doors of a vehicle (such as a pick-up truck (40))
whereby the multi-purpose tailgate sign device is used to safely and quickly deploy a display or signage with a vehicle such as a work truck.

2. The device in claim 1 wherein the means (64) to power and control the display (59) is comprised of:
(a) a connection to the trailer power receptacle (53), a vehicle battery, an auxiliary or supplemental battery, a vehicle or supplemental generator/alternator or a power cord and transformer to an alternating current source (residential or commercial);
(b) main controls (57) (CPU, Circuitry with Inputs—(Keyboard, Phone, Etc.); and alternatively
(c) a remote controller (60); connections (61) (such as Infrared, wireless, Wire); and a remote display (62)(In-Cab, Phone, Etc.) connect (63) on remote display (62) to main controller (57)

3. The device in claim 1 wherein the means (54A), to interconnect the power (55) and control (56) to the display (59) is comprised of:
(a) a wiring/circuit/connection (54) to a trailer connect receptacle (53);
(b) a wiring/connection (56) to the controls (57) to power source (55); and
(c) a means and connections (58)—Controls (Wire or wireless) and power (Wire} to Display.

4. The device in claim 1 wherein the means (38) to removably mount the display (59) to the tailgate (41) or doors of a vehicle such as a pick-up truck (40) is comprised of:
(a) a top clamp component (31);
(b) a bottom clamp component (32);
(c) a series of fasteners (32A);
(d) a top flip which contains frame of a display (33);
(e) a frame (34), made of a durable material, wherein the frame encircles the display (59);
(f) protective cover (35) over display (59); and
(g) cushion pads (36).

5. The device in claim 4 wherein the top clamp component (31) is adjustable.

6. The device in claim 4 wherein the bottom clamp component (32) is adjustable.

7. The device in claim 4 wherein the series of fasteners (32A) each include a nut and bolt, all being threaded and quick connects.

8. The device in claim 4 wherein the protective cover (35) over the display (59) is a transparent and non-breakable high strength plastic.

9. The device in claim 4 wherein a configuration of the frame of a display is from the group consisting of a “ZEE” cross section, a Channel “C” cross section, a tees (T) cross section, an angles (L) cross section, a “H” beams types cross section and an “I” beam cross section.

10. The device in claim 4 wherein the durable material of the frame is from the group consisting of a metal, steel, aluminum, a heavy duty plastic and composite material.
